(19) United States
(12) Patent Application Publication
(10) Pub. No.: US 2013/0282535 A1
(43) Pub. Date: Oct. 24, 2013

(54) REOPENING A FINAL CLOSED PURCHASE ORDER FOR CONTINUATION OF RECEIPT AND INVOICE

(71) Applicants: Mayukh Bhaowal, Redwood City, CA (US); Suman Guha, Fremont, CA (US); Michael L. Webb, Highlands Ranch, CO (US); Shibhu Nambiar, Springfield, VA (US); Lee-Hian Quek, Foster City, CA (US); Angela Xian, Cupertino, CA (US)

(72) Inventors: Mayukh Bhaowal, Redwood City, CA (US); Suman Guha, Fremont, CA (US); Michael L. Webb, Highlands Ranch, CO (US); Shibhu Nambiar, Springfield, VA (US); Lee-Hian Quek, Foster City, CA (US); Angela Xian, Cupertino, CA (US)

(73) Assignee: Oracle International Corporation, Redwood Shores, CA (US)

(21) Appl. No.: 13/452,193

(22) Filed: Apr. 20, 2012

(51) Int. Cl. G06Q 30/00; G06Q 40/00

(52) U.S. Cl. 705/30

(57) ABSTRACT

A method of calculating accounting encumbrance adjustments for a purchase order associated with a first allocation of a budget includes determining that the purchase order has been closed, where the closure prevents additional processing associated with the purchase order by an invoice processing system; receiving a request to reopen the purchase order, where the request is associated with an additional cost; causing a determination to be made as to whether a second portion of the budget should be allocated, where the second portion of the budget corresponds to the additional cost; and in response to a determination that the second portion of the budget can be allocated: causing the second portion of the budget to be allocated, reopening the purchase order, and sending an indication to the invoice processing system that the purchase order is reopened.

### BACKGROUND

When an organization makes a purchase, many different departments and software systems within the organization may be involved. A purchase may begin as a request from a requesting department, and eventually result in a purchase order. Purchase orders may be contractually binding documents between a buying organization and a selling organization. After the creation of a purchase order, the subsequent events in the purchase order's lifecycle may include delivering, receiving, and invoicing activities. For instance, an order for goods may be shipped by a supplier, and then received and delivered to a requester within an organization. The supplier may send an invoice for the order, and an accountant may enter the invoice into a computer system in an accounts payable department of the buying organization.

A buyer, who represents the buying organization within a purchasing department, may have the authority to change the status of a purchase order such that no more receiving or invoicing associated with the purchase order can occur. Such a status is known as “final close.” This status may comprehensively prevent modifications to, or actions against, a purchase order. This may mean that one cannot perform actions against a purchase order that has been final closed, such as receipt, transfer, inspect, deliver, correct receipt quantities, invoice, return to supplier, or return to receiving. Additionally, a purchase order may be final closed when an accounts payable accountant enters an invoice in the system and “final matches” that invoice to the purchase order. If the accountant does not expect any more invoices to be matched with the purchase order, the accountant has the option to “final match” the invoice to the purchase order. This may automatically cause a final close of the purchase order.

### BRIEF SUMMARY

In one embodiment, a method of calculating accounting encumbrance adjustments for a purchase order associated with a first allocation of a budget may include determining that the purchase order has been closed. In one embodiment, the closure may prevent additional processing associated with the purchase order by an invoice processing system. The method may also include receiving a request to reopen the purchase order, In one embodiment, the request is associated with an additional cost. The method may additionally include causing a determination to be made as to whether a second portion of the budget should be allocated. In one embodiment, the second portion of the budget may correspond to the additional cost. The method may further include, in response to a determination that the second portion of the budget can be allocated, causing the second portion of the budget to be allocated, reopening the purchase order, and sending an indication to the invoice processing system that the purchase order is reopened.

In another embodiment, a computer-readable memory is presented. The computer readable memory may have stored thereon a sequence of instructions which, when executed by one or more processors, causes the one or more processors to calculate accounting encumbrance adjustments for a purchase order associated with a first allocation of a budget by determining that the purchase order has been closed, where the closure may prevent additional processing associated with the purchase order by an invoice processing system; receiving a request to reopen the purchase order, where the request may be associated with an additional cost; causing a determination to be made as to whether a second portion of the budget should be allocated, where the second portion of the budget may correspond to the additional cost; and in response to a determination that the second portion of the budget can be allocated: causing the second portion of the budget to be allocated, reopening the purchase order, and sending an indication to the invoice processing system that the purchase order is reopened.

In yet another embodiment, a system is presented, including a processor and a memory communicatively coupled with and readable by the processor. The memory may have stored therein a sequence of instructions which, when executed by the processor, cause the processor to calculate accounting encumbrance adjustments for a purchase order associated with a first allocation of a budget by determining that the purchase order has been closed, where the closure may prevent additional processing associated with the purchase order by an invoice processing system; receiving a request to reopen the purchase order, where the request may be associated with an additional cost; causing a determination to be made as to whether a second portion of the budget should be allocated, where the second portion of the budget may correspond to the additional cost; and in response to a determination that the second portion of the budget can be allocated: causing the second portion of the budget to be allocated, reopening the purchase order, and sending an indication to the invoice processing system that the purchase order is reopened.

The method, system, and computer-readable memory may further include (or include instructions that cause one or more processors to calculate accounting encumbrance adjustments for a purchase order associated with a first allocation of a budget by) causing to be output an indication that reopening the purchase order may require the additional cost; determining that the second portion of the budget may be recorded in an Encumbrance Accounting system; causing the second portion of the budget to be recorded in a sub-ledger within the Encumbrance Accounting system; receiving credentials associated with a user requesting that the purchase order be reopened; determining whether the user requesting that the purchase order be reopened is authorized to reopen the purchase order; sending, in response to a determination that the second portion of the budget should not be allocated, an indication that the purchase order was not reopened to a user requesting that the purchase order be reopened; notifying, in response to a determination that the second portion of the budget can be allocated, an Accounts Payables department; and recording in an audit record: the request to reopen the purchase order, the determination as to whether the second portion of the budget should be allocated, and any actions taken in response to the determination.

Further, the purchase order may be associated with goods or services that are at least partially undelivered or partially unperformed, and the second portion of the budget may be calculated as a multiplicative product of: an undelivered quantity, a unit price, a currency rate, and a Non-Recoverable Tax that is pro-rated for the undelivered quantity in functional currency. Additionally, the purchase order may be associated with goods or services that are at least partially unbilled, and the second portion of the budget may be calculated as a multiplicative product of: an unbilled quantity, a unit price, a currency rate, and a Non-Recoverable Tax that is pro-rated for the unbilled quantity in functional currency.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a block diagram illustrating components of an exemplary operating environment in which various embodiments of the present invention may be implemented.

FIG. 2 illustrates a block diagram illustrating an exemplary computer system in which embodiments of the present invention may be implemented.

FIG. 3 illustrates a flow diagram of a purchase order final close and reopen process in a business organization, according to one embodiment.

FIG. 4 illustrates a block diagram of one or more computer software systems for reopening a purchase order, according to one embodiment.

FIG. 5 illustrates a flow chart of a method for receiving a request to reopen a purchase order, according to one embodiment.

FIG. 6 illustrates a flow chart of a method for reopening a purchase order, according to one embodiment.

FIG. 7 illustrates a block diagram of for determining and allocating a second portion of a budget associated with an additional cost from reopening a purchase order, according to one embodiment.

FIG. 8 illustrates a flow chart of a method for determining a second portion of the budget to be allocated according to an additional cost, according to one embodiment.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

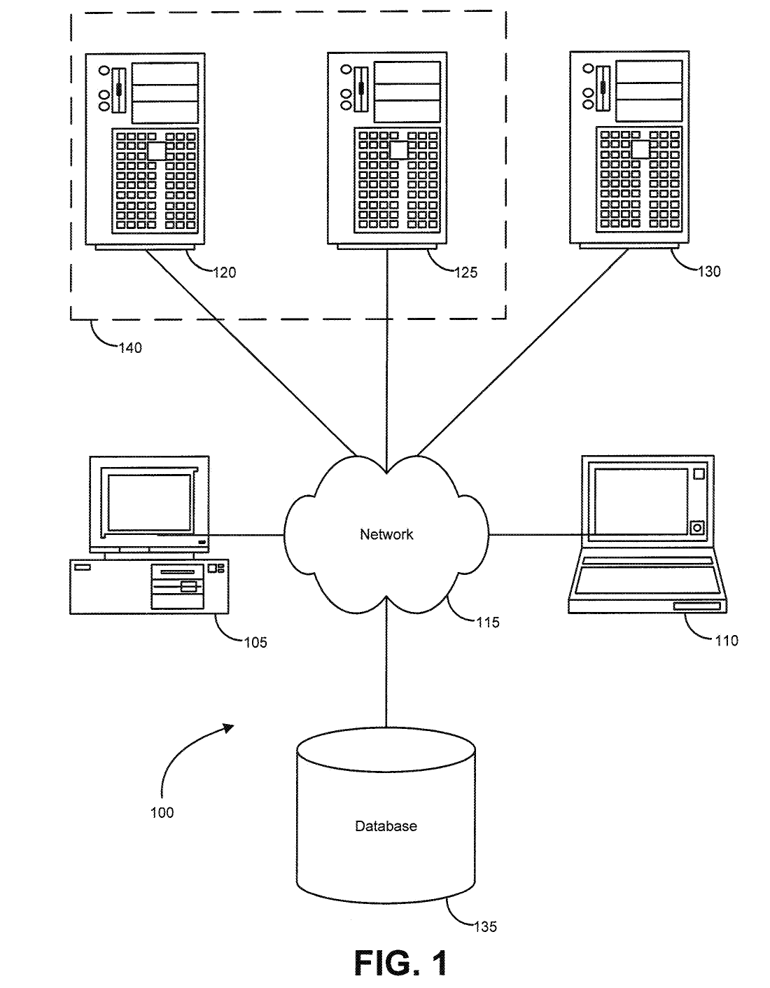

The embodiments disclosed herein may be implemented in a computer system. FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Inc.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

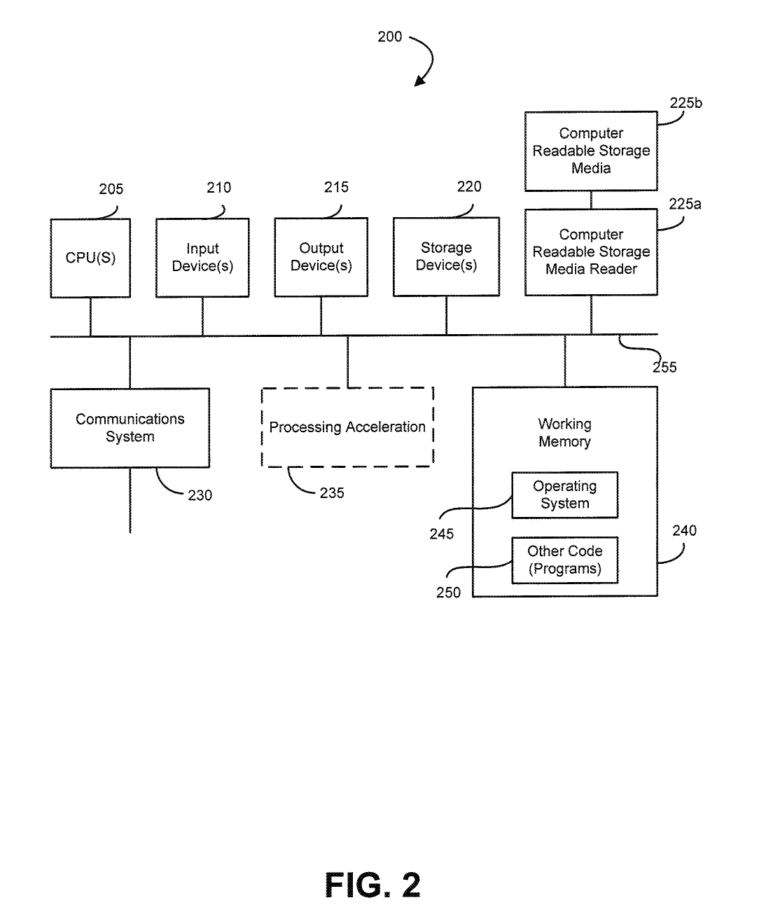

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

Embodiments described herein may present methods, systems, and/or products configured to allow for a purchase order that has been final closed to be reopened. After final close, the purchase order may be reopened such that downstream activities, such as delivery, receipt, and invoicing may once again be carried out. In addition to changing the status of the purchase order, downstream departments, such as a receiving department and an accounts payable department, may also be notified. Organizations that use budgetary controls and/or encumbrance accounting may also determine the financial impact of reopening the purchase order. If additional deliveries against the purchase order would have an adverse effect on a budget, reopening the purchase order may be prevented. Otherwise, the fiscal impact may be calculated and recorded against the budget in a purchasing sub-ledger. Appropriate warnings may be presented to a user, and an audit trail may be recorded regardless of the outcome.

As used herein, the term “finally closed” may refer to a final status of a purchase order. When a purchase order is final closed, it serves to close the transactions associated with the purchase order. Therefore, any “downstream” activity associated with the purchase order may be prevented. Also, final close may cause the liquidation of any remaining funds and/or obligations associated with a purchase order if budgetary controls and/or encumbrance accounting regimes are in place. For example, a purchase order may call for periodic shipments of goods, or periodic performance of services. Each time a shipment of goods is received or services are performed, this may result in an invoice that is matched against the purchase order in the accounts payable department for payment. If the organization decides it wants to stop the periodic shipments or preclude the future performance of services, changing the status of the purchase order to final closed may prevent future receipt of goods and services and/or invoicing and payment.

Therefore, the consequences of final closing a purchase order may be severe and extensive. In current software systems, final closing a purchase order is often an irreversible action. As a consequence, buyers may be hesitant to final close some purchase orders. Additionally, accounts payable accountants may be indecisive, and delay the final match of invoices to purchase orders, which may also delay final close. Thus, a large number of purchase orders may build up that are never final closed simply because of the severity of such an action. Leaving purchase orders open may distort budgeting and accounting processes. This may lead to the inaccurate assumption that more funds are available than really are, or conversely, that funds are tied up in open purchase orders that are no longer being invoiced.

These consequences may be magnified in government accounting systems. Most government accounting systems require budgetary control and/or encumbrance accounting in their business practices. In most private sector accounting systems, there is no mandated requirement to budget for transactions in advance in order to make plans to spending money transparent. In contrast, public sector companies use taxpayer money to fund their projects and other expenditure. Such spending is required by law to follow a strictly formulated budget set aside rules. For example, if an organization created a requisition for a new copier, the cost of the copier could be recorded against the organization's budget at or before the time that the purchase order was made. Simultaneously, when the purchase order is finally closed, any remaining funds that were allocated may be liquidated such that they can be used by other purchase orders. In this situation, if a purchase order is reopened after it is finally closed, purchases may be made against the budget which is not sufficient or that are not recorded in the encumbrance accounting system. This situation may violate public policies when taxpayer dollars are spent. Embodiments described herein may solve this problem by determining a cost associated with reopening a purchase order, and analyzing the effect on an organization's budgetary control requirements and/or under encumbrance accounting requirements.

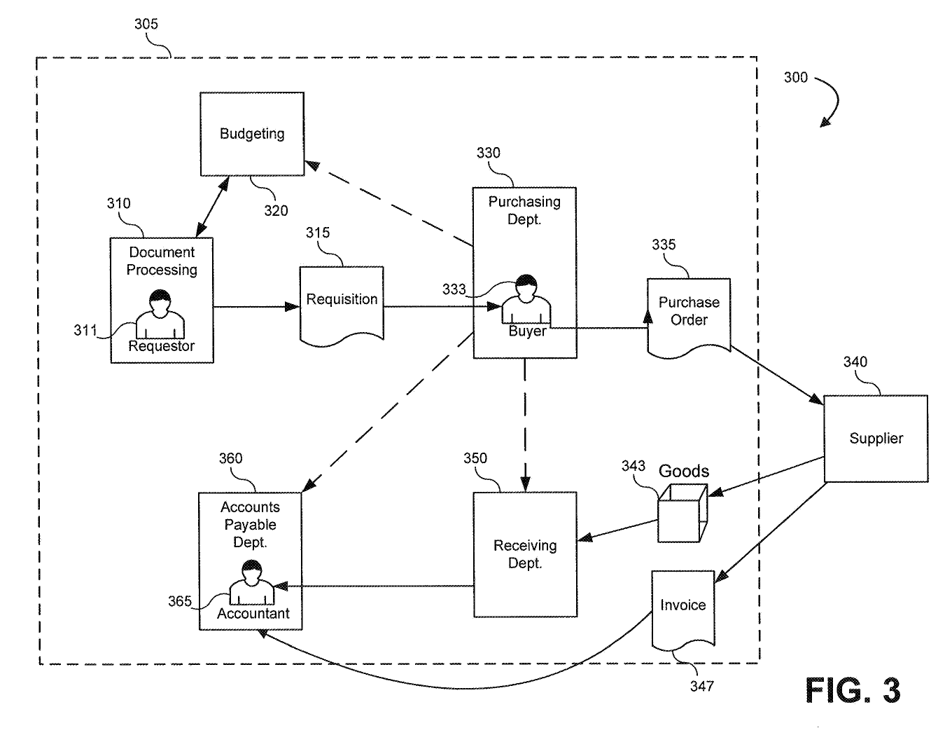

FIG. 3 illustrates a flow diagram 300 of a purchase order final close and reopen process in a business organization, according to one embodiment. The process may begin with a requester 311 in an organization 305 attempting to make a purchase. For example a member of a document-processing department may attempt to purchase a new copy machine, which may include machine itself along with periodic shipments of toner and other service and maintenance agreements. The organization 305 may operate under a budget and require that any purchases be approved by a budgetary authority and/or budgeting department 320. If a budgetary control system is in operation, then the budgeting department 320 may accept or reject the purchase based on the current budget and/or known future expenditures.

In addition to budgetary approval, the organization may also use encumbrance accounting procedures. In this case, a first allocation of the budget may be made to correspond to an initial cost associated with the requested purchase, along with any other costs required by the encumbrance accounting process. This first allocation of the budget may be recorded as an encumbrance journal entry in the purchasing sub-ledger. The purchasing sub-ledger may be separate from the general accounting ledger, and may be periodically incorporated into the general accounting ledger.

If the budgeting department 320 clears the requisition and funds for it are reserved in the budgetary control system as well as corresponding encumbrance accounting events raised, the attempted purchase may result in a requisition 315 from the organization 305 to be routed to a purchasing department 330. A buyer 333 within the purchasing department 330 may analyze the requisition 315 and determine when, where, and how the corresponding purchase may be made. For example, the buyer 330 may use special corporate contracts for a reduced price on the purchase, or the buyer 330 may use special corporate accounts that provide discounts and/or benefits to the organization. The buyer 330 may generally use any corporate resources available to achieve an optimal price and/or service agreement with a supplier 340.

The buyer 333 may use the requisition 315 to create a purchase order 335. In one embodiment, a purchase order may represent a legal contract between the organization 305 and a supplier 340. The purchasing department 330 may insert provisions into the purchase order 335 that allow the purchasing department 332 final close the purchase order and prevent downstream acceptance, invoicing, and/or other operations to continue.

The purchase order 335 may be sent to the supplier 340, who under the general rules of contract law, may accept or reject the purchase order 335. Upon acceptance, the supplier 340 may send the goods 343 and/or services (not pictured) to a receiving department 350 of the organization 305. The supplier 340 may also deliver the goods 343 ordered and send an invoice 347 to the organization 305. The goods 343 may be received by the receiving department 350, and invoice 347 may be received by accounts payable department 360. An accountant 365 within the accounts payable department 360 may accept the invoice 347, and match it to the purchase order 335. If the purchase order 335 represents a single delivery/performance, then the accountant 365 may determine a “final match” between the invoice 347, and the purchase order 335. This final match may have the effect of a final close on the purchase order 335.

Alternatively or additionally, if the purchase order 335 represents more than a single delivery/performance, then the invoice 347 may be matched to the purchase order 335 without being final, i.e. closing the purchase order 335. Thus, in cases where future deliveries on the purchase order 335 are expected, or where future invoices may be matched to the purchase order 335, the purchase order 335 may be left open in order to match those future deliveries/invoices.

In one embodiment, the buyer 333 in the purchasing department 330 may determine that the purchase order 335 should be finally closed. This may occur in cases where the accountant 365 in the accounts payable department 360 failed to correctly final match the invoice 347 to the purchase order 335. Also, the buyer 333 may determine that any future deliveries and/or performances specified in the purchase order 335 may no longer be necessary. For example, the purchase may be for a new copier that includes future deliveries of toner and a service schedule. However, if the copier is outdated and removed from operation, of if the organization 305 sold the copier, then the buyer 333 may final close the purchase order 335 to prevent future deliveries of toner and the future performance of service on the copier. In one embodiment, a final close in the purchasing department 330 may be accompanied by an indication of the final close sent to the receiving department 350 and/or the accounts payable department 360 requesting that they stop processing transactions on the purchase order. Other departments may also be sent a similar indication.

Consequently, a final close may occur in at least two situations: the first in the purchasing department 330, and the second with a final match in the accounts payable department 360. During such a final closure, any remaining funds allocated to this purchase order may be liquidated. In addition, an encumbrance accounting event may be raised to correct any encumbrance accounting entries generated during purchase order creation. However, the purchasing department 330 often may not be aware of circumstances that may require the purchase order 335 to undergo a final close (such as the selling of the copier described above). Similarly, the accounts payable department 360 may often fail to correctly determine that the match between the invoice 347 and the purchase order 335 should be final. In both cases, the finality of the final close action may be delayed indefinitely because either department may be reluctant to prematurely final close the purchase order 335.

In one embodiment, the purchase order 335 may be reopened by the buyer 333 in the purchasing department 330. In order to reopen the purchase order 335, it must first be determined that the purchase order 335 was closed. This information may be a readily available if the final close was made in the purchasing department 330. However, if the final close resulted from a final match in the accounts payable department 360, then such information may be transmitted to a computer system associated with the purchasing department 330.

In one embodiment, reopening the purchase order 335 may be simply changing the status of the purchase order 335 from closed to open. In another embodiment, the budgeting department 320 may need to be consulted. For example, if budgetary controls are in place, then a second portion of the budget may need to be allocated in order to reopen the purchase order 335. The budgetary control department may need to make sure that such additional funds are available for spending in the associated budget to prevent overspending. If reopening the purchase order is associated with an additional cost for future deliveries and/or performances of services, then this cost may need to be approved by the budgeting department 320. The second portion of the budget may be calculated according to methods and equations discussed further herein below.

In another embodiment, if encumbrance accounting procedures are used, then an encumbrance accounting event may need to be raised to record encumbrance journal entries in the sub ledger for the second portion of the budget associated with reopening the purchase order 335. This may help meet legally mandated accounting and reporting requirements of the organization 305. This may also be done to record future liabilities that have been incurred by reopening the purchase order 335 in the encumbrance accounting system.

In embodiments where the final close of the purchase order 335 prevents the accounts payable department 360 from matching invoices to the purchase order 335, reopening the purchase order may result in a second indication being sent to the accounts payable department 360. The second indication may specify that the accounts payable department 360 may match one or more future invoices to the purchase order 335. The indication may specify a specific number of invoices to accept, or may leave the purchase order 335 open for any or all future invoices. Additionally, in embodiments where the final close of the purchase order 335 prevents the receiving department 350 from accepting shipments of goods 343 associated with the purchase order 335, reopening the purchase order 335 may result in another indication being sent to the receiving department 350. This indication may specify that the receiving department 350 may receive one or more future shipments of goods 343 from the supplier 340.

Additional departments may also be involved in the process of both closing and reopening a purchase order. If the function of these departments in relation to the purchased order 335 may be classified as “downstream” processing from the purchasing department 330, then these departments may also be notified in the case of both a final close and a reopening of the purchase order 335. These additional departments may be specific to a particular organization and/or may be commonly used by many organizations. Although not specified here for brevity, they may be treated in a similar manner as the receiving department 350 and the accounts payable department 360 described in FIG. 3.

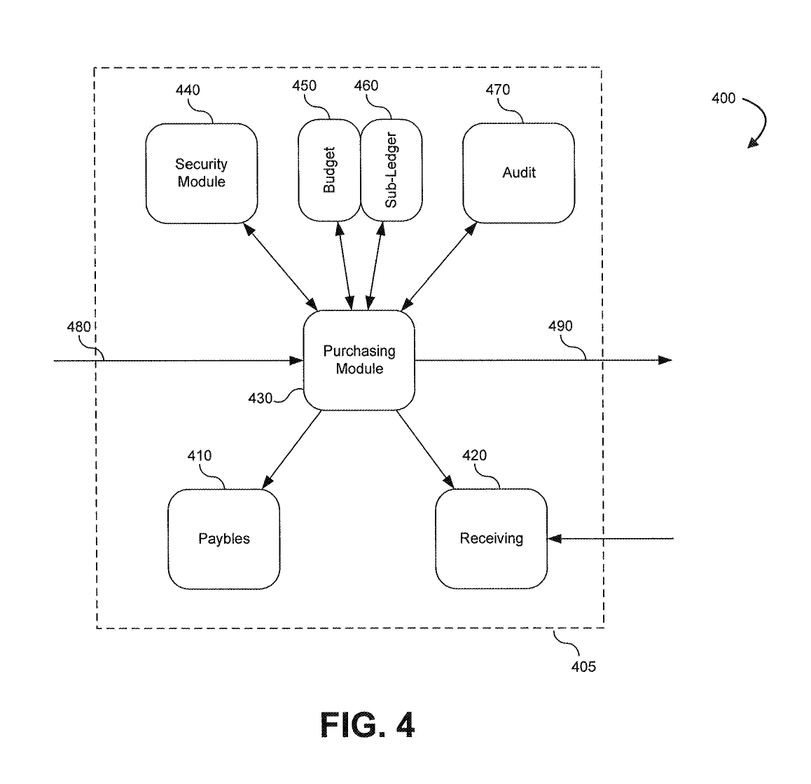

FIG. 4 illustrates a block diagram 400 of one or more computer software systems for reopening a purchase order, according to one embodiment. A purchasing module 430 may be used by the purchasing department 330 to convert the requisition 315 into a purchase order 335. The purchasing module 430 may also be used to final close the purchase order 335 and to subsequently reopen the purchase order 335. The purchasing module 430 may also have additional functionality related to operations of the purchasing department 330. The purchasing module 430 may have an input 480 to receive requisitions, along with an output 490 to send purchase orders to suppliers. The purchasing module 430 may also communicate both unidirectionally and the bidirectionally with many other software modules and with many other computer systems.

In one embodiment, the purchasing module 430 may communicate with a security module 440. The security module 440 may accept a username, password, and/or credentials and determine whether a user is authorized to perform a certain action. For example, the security module 440 may determine whether the buyer 333 in the purchasing department 330 is authorized to reopen the purchase order 335. The purchasing module 430 may also communicate with a budgetary control module 450 and a sub-ledger module 460. The budgetary control module 450 may either make or receive a determination as to whether a portion of the budget may be allocated for a particular purpose. The budgetary control module 450 may make and receive this determination for the purchasing module 430. The sub-ledger module 460 may accept the details of the purchase order or transaction and record these details in an encumbrance journal in the Purchasing sub-ledger. The sub-ledger module 460 may also accept an indication from the purchasing module 430 indicating that the purchase order has been final closed in order to move sub-ledger entries into a general accounting ledger.

An audit module 470 may also communicate with purchasing module 430. The audit module 470 may accept entries into an audit log regarding any and all activities associated with purchasing module 430. In one embodiment, the audit module 470 may record any activity involving the credentials of a user, such as when a user credentials are checked before reopening a purchase order. In another embodiment, any attempts to allocate additional portions of the budget and/or any attempts to record an encumbrance journal entry in the purchasing sub-ledger may also be recorded by the audit module 470 in an audit log. In yet another embodiment, any indications that are sent to a department outside of the purchasing module, such as the receiving department 350 and/or the accounts payable department 360, may also be recorded by the audit module 470. Additionally, the audit module 470 may record any activity that may be required during a financial audit. In another embodiment, a document history table may be used to store document actions taken, such as final close and/or reopen final close. Thus, in an audit requirement, one can look into the document history and find the person accountable for the reopen action. Similarly there may be a history record for the encumbrance journal entries created as well.

An accounts payables module 410 may be used by the accounts payable department 360 to match purchase orders with invoices. The accounts payables module 410 may be in communication with the purchasing module 430 regarding any outstanding invoices to be final matched to a purchase order. Furthermore, the accounts payables module 410 may receive communications from the purchasing module 430 as to whether future invoices may continue to be matched to existing purchase orders. A receiving module 420 may be used by the receiving department 352 to record, route, return, and/or receive shipments from a supplier. The receiving module 420 may also receive commands from the purchasing module 430 as to whether future transactions associated with a particular purchase order may continue to be accepted.

In one embodiment, the various software modules in FIG. 4 may reside on separate computer systems. Alternatively, multiple software modules may be combined on the same or similar computer systems. In addition, some software modules may be combined together into a single software module performing the functions of both individual software modules. For example, the security module 440 may be merged with the purchasing module 430 such that a single module performs the functions of both. Similarly, a single software module may be split into multiple software modules. For example, the security module 430 may be split into one module that verifies a user's identity, and a second module that it evaluates a user's security credentials. It will be understood in light of this disclosure that any arrangement of the software modules, as well as any implementation in both software and hardware, may be used by various embodiments.

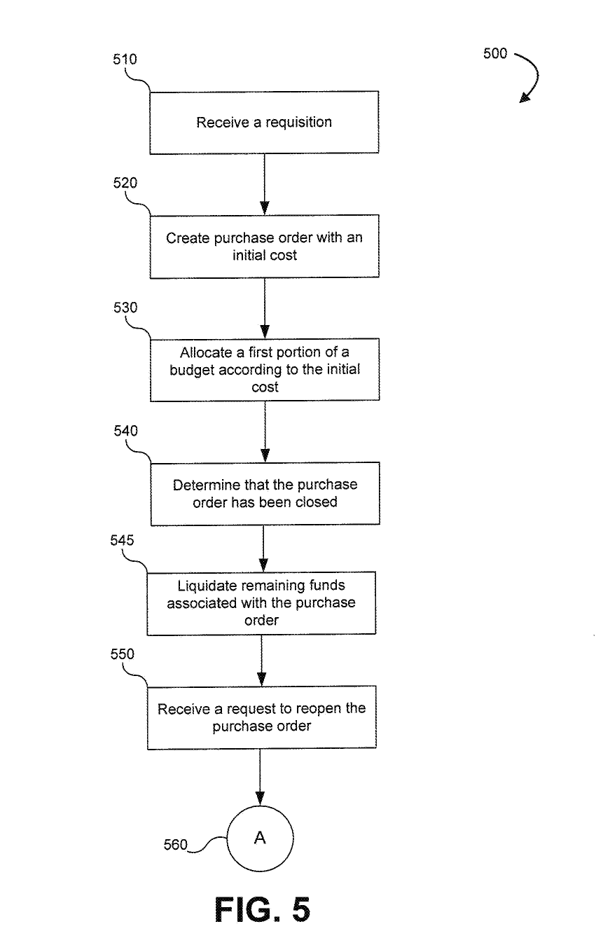

FIG. 5 illustrates a flow chart 500 of a method for receiving a request to reopen a final closed purchase order, according to one embodiment. At step 510 a requisition may be received. The requisition may be received from a department outside of the purchasing department, or it may originate with the purchasing department itself. At step 520, a purchase order may be created with an initial cost associated with the purchase. In one embodiment, the initial cost may simply be the purchase price of a particular item or service. In another embodiment, the initial cost may be determined according to various corporate schedules, corporate agreements, bulk transaction discounts, and/or the like.

At step 530 a first portion of the budget may be allocated according to the initial cost. This may imply that the buying organization approved the request for an item and that the requisition is ready to be sourced to a purchase order to move forward in the procure-to-pay process. The cost may be allocated outside of purchasing department, or it may be allocated inside the purchasing department with an indication sent to the budgetary control module. In cases where the initial cost is simply the purchase price of an item according to a requisition, the first portion of the budget associated with the initial cost may be allocated earlier in the process.

At step 540, a determination may be made that the purchase order has been finally closed. Alternatively, instead of making the determination, the computer system performing the method may actually close the final purchase order. This determination may be made after a period of time has elapsed between the creation of the initial purchase order and a subsequent closure of the purchase order. This determination may also be made after one or more of the items in the purchase order have been received and invoiced. This determination may be made by the purchasing module after a buyer final closes a purchase order. Alternatively or additionally, this determination may be made after receiving an indication from the accounts payable department that the purchase order has been final matched to one or more invoices. In some embodiments, a determination that a purchase order has been final closed may correspond to any state in which additional processing associated with the purchase order may be precluded in both a purchasing software module and additional downstream software modules. Additional processing or “downstream” processing may include any and all transactions associated with the purchase order after it has been created. As described earlier, this may include invoicing, receiving, routing, and/or the like. In some embodiments, there may be a final closed status associated with a purchase order, and that status may be referenced by downstream software modules to preclude downstream processing. In other embodiments, final closing a purchase order may have the effect of canceling future scheduled transactions.

At step 545, any remaining funds associated with the purchase order may be liquidated. When the purchase order is closed, these funds may be freed for new purchase orders. At step 550, a request may be received to reopen the purchase order that has been closed. This request may come from outside the purchasing department, such as from a customer buying organization. The request may also come from an accounts payable department in response to additional invoices being received. In one embodiment, the request may come from a buyer in the purchasing department itself The request to reopen the purchase order may be a request to change the final closed status of the purchase order to an open status. The status change may enable future downstream processing to occur, even if such are unscheduled at the time the request is made. Alternatively or additionally, the request to reopen the purchase order may result in the scheduling or authorization of specific future downstream transactions and/or processing that were cancelled when the purchase order was final closed.

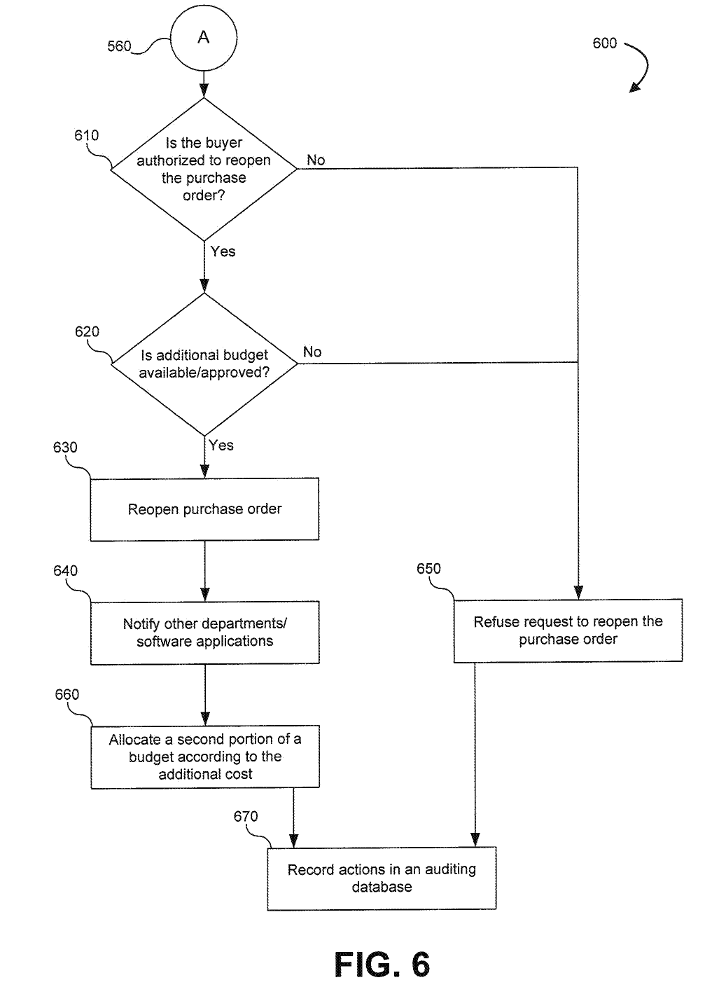

FIG. 6 illustrates a flow chart 600 of a method for reopening a purchase order, according to one embodiment. Flowchart 600 may be a continuation of a flow chart 500 at step 560 labeled as “A”. After receiving a request to reopen a purchase order, a determination may be made as to whether the individual or system making the request is authorized to reopen the purchase order at step 610. This determination may be made by the purchasing module 430, or to be made by the security module 440. The buyer's identity may be ascertained, the buyer's department may be checked, and/or the buyer's employee level may be verified. In one embodiment, only employees at the level of administrator, or manager may be allowed to reopen the purchase order. The security module maintains special rights or privileges. One such privilege may be the ability to reopen a purchase order. Such privileges can then be assigned to Roles, which can then be granted to users. So, a user can be granted a “Advanced Buyer” role, which is associated with the privilege to reopen a finally closed purchase order. Using such privileges and role based security mechanism, the system can restrict unauthorized personnel from reopening a finally closed purchase order. In another embodiment, a buyer may be required to supply security credentials, such as a one-time-use password or pin that will authorize a specific purchase order to be reopened. For example, the buyer 333 in the purchasing department 330 of FIG. 3 may be given a limited number of pin codes to use in a given time period for reopening purchase orders. For instance, the buyer 333 may be limited to two reopened purchase orders per year. In another embodiment, a manager of the purchasing department 330 and/or the buying organization 310 may approve a purchase order to be reopened and supply the requester with an authorization code. The authorization code may be used to reopen only the specific purchase order as authorized by the manager. It will be understood in light of this disclosure, the many different types of security authorization may be used by various embodiments discussed herein.

The security module enforces Role Based Access Control. The system may include a reference implementation that is a set of roles with privileges to perform the work needed for that role. The role definitions include a set of segregation-of-duties. Segregation-of-Duties includes the checks and balances to ensure people cannot take actions outside of their defined duty roles. In another embodiment roles are categorized into four categories; Job, Duty, Abstract and Data roles. Job roles signify roles those are close to job titles. An example of a job role might be a Buyer. It describes what people do for a living and comes with appropriate access rights. Duty roles describe what the user does, such as a job description. For example a buyer can be granted duty roles such as Purchase Order Creation and Administration. It entitles the buyer to create and administer purchase orders. Each duty role may in turn comprise a set of associated tasks or privileges. For example purchase order administration duty role can consist of the privilege to Final Close or Reopen a Purchase Order.

Abstracts are roles that are inherited and are not real in and of themselves. They may be inherited as part of the job role. Employee and Line Manager are examples of an abstract role. Most of the job roles will inherit the role of Employee. With this role comes the privilege to create a requisition, submit expenses, and enroll in training Lastly, data roles may be considered the real building blocks of data security. A data role has been granted privileges over a set of data. As an example, a buyer may be authorized to manage purchase orders for a particular business organization department or cost center. Thus, this allows for a more advanced security mechanism, where although the buyer has been granted the duty role and may be privileged to reopen finally closed purchase orders, such a privilege is restricted to only purchase orders originating from a specific business department. Such a multi-tier security mechanisms may be tightly integrated with the methods and systems disclosed herein.

In one embodiment, purchase orders may be divided into separate classes or categories that require different security credentials. For example, one class of purchase orders may be classified as low-risk, and may describe purchase orders with low dollar costs, with small transactions, and/or with suppliers with whom a reliable relationship has been established. Thus, a purchase order with a supplier that has been a long-term customer of the purchasing organization may be considered low-risk even for high dollar amounts. Another class of purchase orders may be classified as high-risk. These purchase orders may be associated with large costs, large quantity purchases, and or purchases from unknown or less reliable suppliers. Different types of security credentials may be required for each class or category of purchase order.

In another embodiment, purchase orders may be categorized based on the accounts from which they are charged. For example, a purchase order from an account that requires budgetary controls and/or encumbrance accounting procedures they require one level of security credentials and/or authorizations. In contrast, a purchase order from account that does not use budgetary controls may require a second, or lesser, level of security credentials. Similarly, purchase orders may be categorized based on the remaining funds in the accounts from which they are charged. For example, a purchase order associated with an account with a large amount of remaining funds may be categorized as low-risk, while a purchase order associated with an account with few remaining funds may be categorized as high-risk. Thus, purchase orders may transition from a low-risk to a high-risk classification as funds in associated accounts change throughout a financial cycle.

If it is determined that the buyer does not have the proper identity, credentials, and/or authorizations to reopen the purchase order, the request may be refused at step 650. In one embodiment the refusal to reopen a purchase order may not have any effect on the status of the final closed purchase order. In another embodiment, the refusal to reopen a purchase order may set a flag or indicator associated with the purchase order requiring additional security authorization. For example, if it is determined that a requester is not authorized to reopen a particular purchase order, then a flag may be set indicating that any future attempts to reopen the purchase order may require a specific management approval. This may be beneficial for detecting and preventing fraud, and/or mistakes associated with high-value purchase orders, or with purchase orders wherein multiple requests are received. In one embodiment, refusal to reopen a low-risk purchase order may change the category or class to that of a high-risk purchase order.

Additionally, if the request to reopen the purchase order is not successful, an indication may be provided to a user responsible for the request. In one embodiment, the user may be the buyer 333 in the purchasing department 330. In another embodiment, the user may be the customer 311 or another member of the buying organization 310. The indication may include a reason that the request was unsuccessful, along with conditions that may be met such that a subsequent request might be successful. For example, an indication might be provided that the user does not have sufficient security privileges or that there are not sufficient funds available in the allocated budget. In another example, the indication may indicate that the additional cost associated with reopening the purchase order was too high, and that reducing the additional cost may result in a successful request.

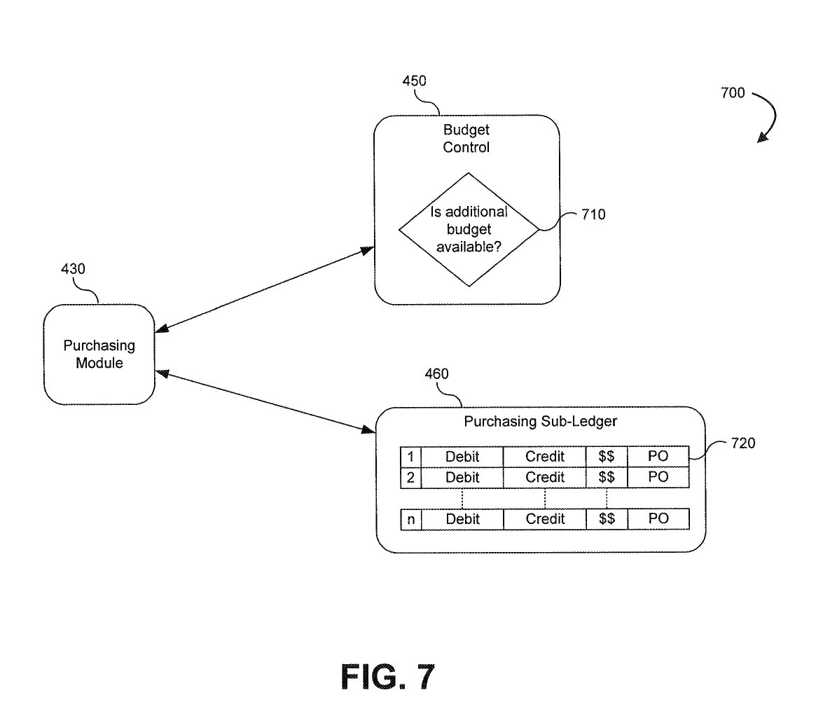

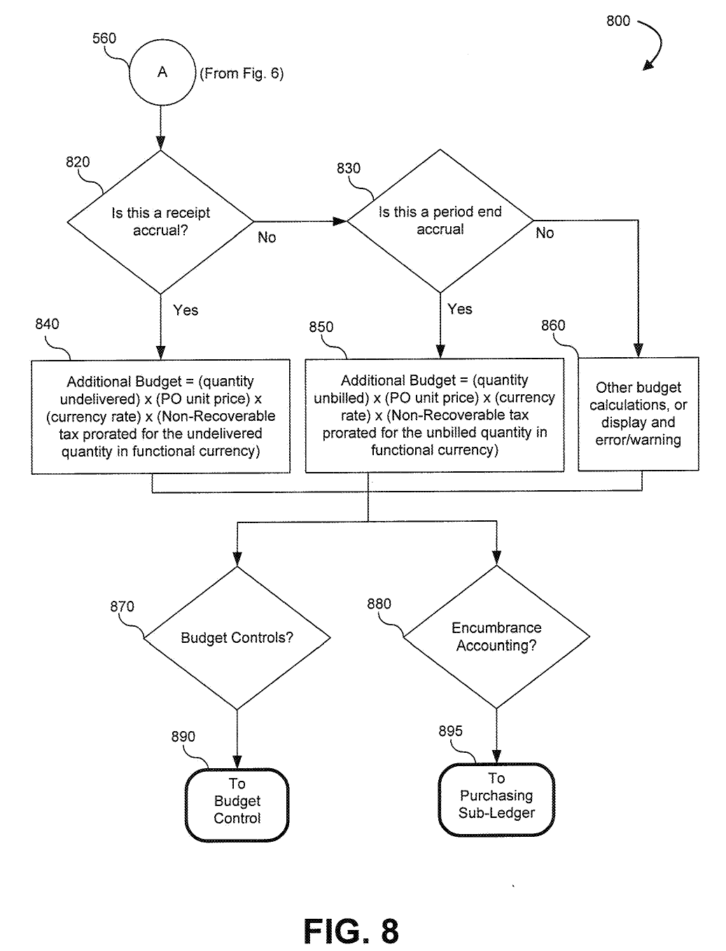

At step 620, a determination may be made as to whether the additional budget associated with reopening the purchase order is available. This step may depend upon the type of budgeting and accounting procedures used by an organization, and will be discussed in greater detail in relation to FIG. 7 and FIG. 8. If a determination may be made that the additional budget is available, and that the buyer is authorized to reopen the purchase order, then the purchase order may be reopened at step 630. If a determination is made that the additional budget is unavailable, then the method may proceed as before to step 650.

After the purchase order is reopened in step 630, other departments and/or software modules may be notified in step 640. As described earlier, this notification may be sent to the accounts payable department 360, the receiving department 350, and any other departments involved in downstream processing of purchase order that has been reopened. This notification may be sent to software modules corresponding to each department by any communication method, such as e-mail, direct messaging, or as a data stream. In one embodiment, these separate software modules may be part of one integrated enterprise software system. In this case, sending a notification may amount to simply changing the status of the purchase order in a memory location. This memory location may be checked by each software module in enterprise system without the need for explicit messages sent between software modules.

Finally, after reopening the purchase order, a second portion of the budget may be allocated according to the additional cost at step 660. The calculation of the second portion of the budget to be allocated is discussed in greater detail below in connection with FIG. 7 and FIG. 8.

In cases where the purchase order is reopened, as well as in cases where the request to reopen the purchase order is refused, actions may be recorded as a part of the purchase order document history in the auditing module at step 670. In one embodiment, the audit module 470 may record any actions in relation to closing and reopening a purchase order that may be internally beneficial for organization. For example, events may be recorded to generate a statistic that indicates the percentage of reopen requests that are successful. In another embodiment, the audit module 470 may record each failed attempt by particular requester. When the number of failed attempts for any one requester reaches a certain threshold, an indication may be sent to a manager or a software security department. Additionally, a statistic may indicate the number of purchase orders reopened or finally closed in a particular time period, filtered by several attributes, including but not limited to, the buyer, the cost, the department etc. Also, statistics from the audit logs may be used to determine an effect on the budget for each department that resulted from reopening purchase orders.

In addition to producing statistics for internal analysis by an organization, step 670 may record actions in an audit log that may be required for government compliance. Public-sector organizations may face higher scrutiny along with additional accounting requirements. In the case of the encumbrance accounting, it may be beneficial to create a complete audit trail of all actions that would affect the encumbrance journal entries in the purchasing sub-ledger, as well as the general accounting ledger. Therefore, step 670 may take as input a set of accounting rules, and record actions in an audit log according to the set of accounting rules. Later, if an audit was required of the organization's encumbrance accounting procedures, the audit log could be analyzed and processed to produce an accounting report. The accounting report may demonstrate that actions taken in response to a request to reopen a purchase order conform to the set of accounting rules.

FIG. 7 illustrates a block diagram 700 for determining and allocating a second portion of a budget associated with an additional cost from reopening a purchase order, according to one embodiment. The purchasing module 430 may communicate with the budgetary control module 450 to determine whether an additional budget is available at decision block 710. In one embodiment, the budgetary control module 450 need only provide a response in cases where budgetary controls are enacted. In other words, if the budgetary controls are disabled, the purchaser may be reopened without invoking the budgetary control module 450. In another embodiment, approval from the budgetary control module 450 may also include manual approval by a human input from a manager or administrator associated with budgeting for the organization. In yet another embodiment, approval may be fully automated by a computer system. If an additional cost is below a first threshold, then the associated purchase order may be reopened without further processing. If the additional cost is above the first threshold but below a second threshold, then the associated purchase order may be reopened after additional information is provided, such as an explanation, an authorization code, an additional account number, and/or the like. If the additional cost is above the second threshold, then the computer system may require human input for approval, or deny the request.

The purchasing module 430 may also communicate with the sub-ledger module 460. In one embodiment, no determinations may need to be made by the sub-ledger module 460. Instead, the sub-ledger module 460 need only record a second allocation of the budget associated with reopening a purchase order. This recordation may be in the form of an entry 720 in an accounting table or database. The entry 720 in the accounting table or database may be moved from the purchasing sub-ledger to the general accounting ledger when the additional cost is associated with an invoice, according to general accounting rules.

In one embodiment, the sub-ledger module 460 and the budgetary control module 450 may operate independently. Therefore, budgetary controls may be operational, whereas encumbrance accounting procedures may be disabled. Conversely, budgetary controls may be disabled, while encumbrance accounting procedures may be enforced. Although related, these two operations need not operate with each other. In one embodiment however, the budget control module 450 may act as a gatekeeper to the sub-ledger module 460. For example, the purchasing module 430 may wait until it receives approval from the budgetary control module 450 before is allowed to cause an entry to be made by the sub-ledger module 460. In this embodiment, budgetary controls may protect the encumbrance accounting sub-ledger from recording unapproved transactions.

In cases where the purchasing module 430 and the budgetary control module 450 are separate software modules or reside on separate computer systems, control of the approval process may be split between the two modules. In one embodiment, the purchasing module 430 may cause a determination to be made in the budgetary control module 450 by supplying it with an input and directing it to make such determination. In another embodiment, the purchasing module may receive feedback from the budgetary control module 450, and the purchasing module 450 may make the actual determination. Whether the determination is made in the budgetary control module 450 or the purchasing module 430, the purchasing module 430 may be said to cause such determinations to be made. For example, if the purchasing module 430 sends a request to the budgetary control module 450 to determine whether a second portion of the budget may be allocated, the purchasing module 430 may be said to cause this determination to take place. This same logic may apply to the sub-ledger module 460. Whether the purchasing module 430 writes the entry 720 to the sub-ledger, or the sub-ledger module 460 writes the entry 720 to the sub-ledger, the processing module 438 may be said to cause such action to take place.

FIG. 8 illustrates a flow chart 800 of a method for determining a second portion of the budget to be allocated according to an additional cost, according to one embodiment. Flowchart 800 may encompass portions of flowchart 600 in FIG. 6, such as step 620 and step 660. An important aspect of reversing a purchase order final closure may be the additional calculations involved to determine the funds that need to be additionally reserved for encumbrance accounting purposes for the purchase order. In practice, two common scenarios may often arise. In one embodiment, a receipt accrual situation may occur. Receipt accrual is an accounting industry term. Under the receipt accrual method, transactions are counted/accounted for when the order is made and the item is delivered, regardless of when the money for them is actually received or paid.

Beginning at step 560, the request may be received to reopen a final closed purchase order. At decision block 820, it may be determined whether the purchase order is a receipt accrual. If it is determined that this is a receipt accrual situation, then at step 840, the second, or additional portion of the budget that would need to be allocated may be calculated by determining the multiplicative product of a number of different factors. In one embodiment, the second portion of the budget may be calculated by multiplying an undelivered quantity, a purchase order unit price, a currency rate, and a Non-Recoverable tax prorated for the undelivered quantity in functional currency.

The ordered quantity may represent a quantity of an item ordered as specified in the purchase order. The delivered quantity may represent a quantity of the item received and delivered to the buying organization from the supplier. The undelivered quantity may represent a remaining quantity of the item that still needs to be delivered by the supplier to the buying organization. A purchase order amount may include two kinds of tax components. First, a recoverable tax can be recovered later after filing tax returns and receiving a refund. Second, a non-recoverable portion of the tax may also apply that cannot be recovered by filing a tax return. For a currency rate, there are occasions when the purchase order is issued in a different currency than the currency used for recording the journals in the general ledger of the organization. In such cases it is important to convert the purchase order amount into the currency of the ledger of the buying organization. Currency rate determines this conversion rate from the purchase order currency to the ledger currency. Ledger currency may also be known as functional currency.

The second common scenario may involve period end accruals. Like receipt accrual, period end accrual is an accounting industry term. For the period end accruals method, transactions are accounted when invoices are created for the items ordered, regardless of when the money is actually received or paid. Alternatively transactions may be accounted at the end of a specific accounting period if those transactions are still uninvoiced. At step 850, it may be determined whether the purchase order to be reopened involves a period end accrual. If it is determined that this is a period end accrual situation, then at step 850, the second, or additional portion of the budget that would need to be allocated can again be calculated by determining the multiplicative product of a number of different factors. In one embodiment, the second portion of the budget may be calculated by multiplying an unbilled quantity, a purchase order unit price, a currency rate, and a Non-Recoverable tax prorated for the undelivered quantity in functional currency.

Other scenarios may occur that involve additional equations for calculating any additional budget that would need to be allocated in order to reopen a purchase order. In general, the additional budget may be determined at step 860 by multiplying the cost of additional goods or services with a currency rate and the Non-Recoverable tax that is prorated for the new liability. It will be understood in light of this disclosure that many different types of purchase orders may be reopened, and additional budget may be calculated according to various algorithms by different embodiments that correspond to the actual cost incurred according to encumbrance accounting rules.

After the additional, or second portion of the budget is determined at step 840, step 850, or step 860, that information may be used in accordance with budgetary controls and or encumbrance accounting procedures. At decision block 870, it may be determined whether budgetary controls are in place. If budgetary controls are in place, then the additional, or second portion of the budget may be allocated and sent to the budgetary control module 450 for approval. Additionally, if it is determined at decision block 880 that encumbrance accounting procedures are in place, then the second portion of the budget to be allocated along with other details of the transaction may be sent to the sub-ledger module 460 for recording.

Although flowchart 800 shows two branches involving decision block 870 and decision block 880 occurring in parallel, these two steps of the process may be carried out in any order. As described earlier, one of these two branches may be dependent on the successful completion of the other branch. Additionally, either of the two branches may be eliminated, while the other remains active.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

1. A method of calculating accounting encumbrance adjustments for a purchase order associated with a first allocation of a budget, the method comprising:
determining, using a computer system, that the purchase order has been final closed, wherein:
the purchase order represents an ongoing contractual obligation to receive goods/services from a supplier;
the final closure terminates the ongoing contractual obligation to receive the goods/services from the supplier;
the final closure liquidates any remaining funds that were allocated in a budgetary system for the ongoing contractual obligation to receive the goods/services from the supplier; and
the final closure prevents additional processing of invoices associated with the purchase order by an invoice processing system;
receiving, using the computer system, a request to reopen the purchase order, wherein the request is associated with an additional cost representing funds needed to reestablish the receiving of the goods/services from the supplier;
causing, using a computer system, a determination to be made as to whether a second portion of the budget should be allocated, wherein the second portion of the budget corresponds to the additional cost; and
in response to a determination that the second portion of the budget can be allocated:
causing, using the computer system, the second portion of the budget to be allocated;
reopening, using the computer system, the purchase order; and
sending, using the computer system, an indication to the invoice processing system that the purchase order is reopened such that the invoice processing system will be allowed to process invoices associated with the receiving of the goods/services from the supplier as specified by the purchase order.

2. The method of claim 1, wherein:
the purchase order is associated with goods or services that are at least partially undelivered or partially unperformed; and
the second portion of the budget is calculated as a multiplicative product of:
an undelivered quantity;
a unit price;
a currency rate; and
a Non-Recoverable Tax that is pro-rated for the undelivered quantity in functional currency.

3. The method of claim 1, wherein:
the purchase order is associated with goods or services that are at least partially unbilled; and
the second portion of the budget is calculated as a multiplicative product of:
an unbilled quantity;
a unit price;
a currency rate; and
a Non-Recoverable Tax that is pro-rated for the unbilled quantity in functional currency.

4. The method of claim 1, further comprising causing to be output an indication that reopening the purchase order will require the additional cost.

5. The method of claim 1, further comprising:
determining that the second portion of the budget should be recorded in an Encumbrance Accounting system; and
causing the second portion of the budget to be recorded in a sub-ledger within the Encumbrance Accounting system.

6. The method of claim 1, further comprising:
receiving credentials associated with a user requesting that the purchase order be reopened; and
determining whether the user requesting that the purchase order be reopened is authorized to reopen the purchase order.

7. The method of claim 1, further comprising:
sending, in response to a determination that the second portion of the budget should not be allocated, an indication that the purchase order was not reopened to a user requesting that the purchase order be reopened.

8. The method of claim 1, further comprising:
notifying, in response to a determination that the second portion of the budget can be allocated, an Accounts Payables department.

9. The method of claim 1, further comprising recording in an audit record:
the request to reopen the purchase order;
the determination as to whether the second portion of the budget should be allocated; and
any actions taken in response to the determination.

10. A non-transitory computer-readable memory having stored thereon a sequence of instructions which, when executed by one or more processors, causes the one or more processors to calculate accounting encumbrance adjustments for a purchase order associated with a first allocation of a budget by:
determining that the purchase order has been final closed, wherein:
the purchase order represents an ongoing contractual obligation to receive goods/services from a supplier;
the final closure terminates the ongoing contractual obligation to receive the goods/services from the supplier;
the final closure liquidates any remaining funds that were allocated in a budgetary system for the ongoing contractual obligation to receive the goods/services from the supplier; and
the final closure prevents additional processing of invoices associated with the purchase order by an invoice processing system;
receiving a request to reopen the purchase order, wherein the request is associated with an additional cost representing funds needed to reestablish the receiving of the goods/services from the supplier;
causing a determination to be made as to whether a second portion of the budget should be allocated, wherein the second portion of the budget corresponds to the additional cost; and
in response to a determination that the second portion of the budget can be allocated:
causing the second portion of the budget to be allocated;
reopening the purchase order; and
sending an indication to the invoice processing system that the purchase order is reopened such that the invoice processing system will be allowed to process invoices associated with the receiving of the goods/services from the supplier as specified by the purchase order.

11. The non-transitory computer-readable memory according to claim 10, wherein:
the purchase order is associated with goods or services that are at least partially undelivered or partially unperformed; and
the second portion of the budget is calculated as a multiplicative product of:
an undelivered quantity;
a unit price;
a currency rate; and
a Non-Recoverable Tax that is pro-rated for the undelivered quantity in functional currency.

12. The non-transitory computer-readable memory according to claim 10, wherein:
the purchase order is associated with goods or services that are at least partially unbilled; and
the second portion of the budget is calculated as a multiplicative product of:
an unbilled quantity;
a unit price;
a currency rate; and
a Non-Recoverable Tax that is pro-rated for the unbilled quantity in functional currency.

13. The non-transitory computer-readable memory according to claim 10 wherein the instructions further cause the one or more processors to calculate accounting encumbrance adjustments for a purchase order associated with a first allocation of a budget by:
causing to be output an indication that reopening the purchase order will require the additional cost;
determining that the second portion of the budget should be recorded in an Encumbrance Accounting system; and
causing the second portion of the budget to be recorded in a sub-ledger within the Encumbrance Accounting system.

14. The non-transitory computer-readable memory according to claim 10 wherein the instructions further cause the one or more processors to calculate accounting encumbrance adjustments for a purchase order associated with a first allocation of a budget by:
receiving credentials associated with a user requesting that the purchase order be reopened;
determining whether the user requesting that the purchase order be reopened is authorized to reopen the purchase order; and
sending, in response to a determination that the second portion of the budget should not be allocated, an indication that the purchase order was not reopened to the user requesting that the purchase order be reopened.

15. The non-transitory computer-readable memory according to claim 10 wherein the instructions further cause the one or more processors to calculate accounting encumbrance adjustments for a purchase order associated with a first allocation of a budget by:
notifying, in response to a determination that the second portion of the budget can be allocated, an Accounts Payables department; and
recording in an audit record:
the request to reopen the purchase order;
the determination as to whether the second portion of the budget should be allocated; and
any actions taken in response to the determination.

16. A system comprising:
a processor; and
a memory communicatively coupled with and readable by the processor and having stored therein a sequence of instructions which, when executed by the processor, cause the processor to calculate accounting encumbrance adjustments for a purchase order associated with a first allocation of a budget by:
determining that the purchase order has been final closed, wherein:
the purchase order represents an ongoing contractual obligation to receive goods/services from a supplier;
the final closure terminates the ongoing contractual obligation to receive the goods/services from the supplier;
the final closure liquidates any remaining funds that were allocated in a budgetary system for the ongoing contractual obligation to receive the goods/services from the supplier; and
the final closure prevents additional processing of invoices associated with the purchase order by an invoice processing system;
receiving a request to reopen the purchase order, wherein the request is associated with an additional cost representing funds needed to reestablish the receiving of the goods/services from the supplier;
causing a determination to be made as to whether a second portion of the budget should be allocated, wherein the second portion of the budget corresponds to the additional cost; and
in response to a determination that the second portion of the budget can be allocated:
causing the second portion of the budget to be allocated;
reopening the purchase order; and
sending an indication to the invoice processing system that the purchase order is reopened such that the invoice processing system will be allowed to process invoices associated with the receiving of the goods/services from the supplier as specified by the purchase order.

17. The system of claim 16, wherein:
the purchase order is associated with goods or services that are at least partially unbilled; and
the second portion of the budget is calculated as a multiplicative product of:
an unbilled quantity;
a unit price;
a currency rate; and
a Non-Recoverable Tax that is pro-rated for the unbilled quantity in functional currency.

18. The system of claim 16 wherein the instructions further the processor to calculate accounting encumbrance adjustments for a purchase order associated with a first allocation of a budget by:
causing to be output an indication that reopening the purchase order will require the additional cost;
determining that the second portion of the budget should be recorded in an Encumbrance Accounting system; and
causing the second portion of the budget to be recorded in a sub-ledger within the Encumbrance Accounting system.

19. The system of claim 16 wherein the instructions further the processor to calculate accounting encumbrance adjustments for a purchase order associated with a first allocation of a budget by:
receiving credentials associated with a user requesting that the purchase order be reopened;
determining whether the user requesting that the purchase order be reopened is authorized to reopen the purchase order; and
sending, in response to a determination that the second portion of the budget should not be allocated, an indication that the purchase order was not reopened to the user requesting that the purchase order be reopened.

20. The system of claim 16 wherein the instructions further the processor to calculate accounting encumbrance adjustments for a purchase order associated with a first allocation of a budget by:
notifying, in response to a determination that the second portion of the budget can be allocated, an Accounts Payables department; and
recording in an audit record:
the request to reopen the purchase order;
the determination as to whether the second portion of the budget should be allocated; and
any actions taken in response to the determination.
